(19) United States
(12) Patent Application Publication
(10) Pub. No.: US 2015/0066995 A1
(43) Pub. Date: Mar. 5, 2015

(54) APPARATUS AND METHOD FOR CONNECTING NOSQL DATA AND LINKED DATA

(71) Applicant: Electronics and Telecommunications Research Institute, Daejeon (KR)

(72) Inventors: Soon-Hyun KWON, Incheon (KR); Dong-Hwan PARK, Daejeon (KR); Hyo-Chan BANG, Daejeon (KR)

(21) Appl. No.: 14/473,257

(22) Filed: Aug. 29, 2014

(30) Foreign Application Priority Data
Sep. 2, 2013 (KR) 10-2013-0105117
Aug. 7, 2014 (KR) 10-2014-0101827

(51) Int. Cl. G06F 17/30

(52) U.S. Cl. CPC G06F 17/30569; G06F 17/30289; G06F 17/30312
USPC 707/809

(57) ABSTRACT

Apparatus and method for connecting NoSQL data and linked data are provided. The method includes converting the NoSQL data into RDF data, and issuing the converted RDF data as the linked data; collecting extended linked data extended by connecting the issued linked data and external linked data; and storing the collected extended linked data as the NoSQL data. Accordingly, a dynamic virtuous circulation structure capable of utilizing advantages and mutually compensating for disadvantages of each of the NoSQL data and the linked data can be constructed.

### CROSS-REFERENCE TO RELATED APPLICATION

This application claims priority to and the benefit of Korean Patent Application No. 2013-0105117, filed on Sep. 2, 2013 and Korean Patent Application No. 2014-0101827, filed on Aug. 7, 2014, the disclosure of which is incorporated herein by reference in its entirety.

### BACKGROUND

1. Field of the Invention

The present invention relates to technology of connecting different types of data.

2. Discussion of Related Art

Recently, due to emergence of big data and of congestion of Internet-based services by the explosive spread of smart phones and prevalence of cloud computing, a big change in an existing domain-based information service has become inevitable. Importance of data in this environment has emerged, and many studies regarding data analysis in the big data environment are being progressed.

Recently, data of a not only structured Query language (NoSQL) which is technology emerged from the storage and analysis perspective of the big data and data of a linked data type which has become a hot issue by disclosure and sharing of information are being frequently emerged.

However, the data has a type limited to a technical emergence background, and the data has a lot of advantages but also a lot of issues to be solved.

The NoSQL data does not represent a relationship between data for storing data in a large capacity, and is suitable for a statistical arrangement analysis through collection of each data. Accordingly, in order to analyze by changing the perspective, it has a disadvantage in which a new data set is input and a new data analysis is performed from the beginning, due to an interrelation of the data and an expansion problem of a dynamic data set.

On the other hand, the linked data highly regards a relationship between data, and is a data structure capable of accessing infinite information of the Web based on the relationship. The linked data is suitable for an analysis of a method of conducting a new knowledge by integrating data based on semantic relations of data, but is not suitable for a quantitative analysis of large amounts of data such as the statistical analysis.

### SUMMARY OF THE INVENTION

The present invention is directed to apparatus and method for connecting NoSQL data and linked data by utilizing advantages of each data structure and mutually compensating for disadvantages of each structure.

The present invention is directed to apparatus and method for connecting NoSQL data and linked data at a data level.

According to one aspect of the present invention, there is provided a method of connecting NoSQL data and linked data, including: converting the NoSQL data into RDF data, and issuing the converted RDF data as the linked data; collecting extended linked data extended by connecting the issued linked data and external linked data; and storing the collected extended linked data as the NoSQL data.

As an embodiment, the converting of the NoSQL data into the RDF data may include: converting the NoSQL data which is a target into a middle format of a type which is compatible with the RDF data; and converting the converted NoSQL data into the RDF data by applying a predetermined data conversion rule to the NoSQL data converted into the middle format.

As an embodiment, the method may further include: selecting the NoSQL data including a key defined in the predetermined data conversion rule as the NoSQL data which is the target with reference to the predetermined data conversion rule.

As an embodiment, the middle format and the predetermined data conversion rule may have a JSON format.

As an embodiment, the method may further include: performing verification on the converted RDF data with reference to schema information defined in a predetermined ontology model.

As an embodiment, the collecting of the extended linked data may include: receiving collection queries being executed on at least one LOD which is a collection target of the extended linked data; and collecting the extended linked data by executing the received collection queries.

As an embodiment, the collection queries may be written as SPARQL.

As an embodiment, the storing of the collected extended linked data as the NoSQL data may include: storing the collected extended linked data as the NoSQL data using an API supported by a NoSQL database.

As an embodiment, the data conversion rule may include: at least one among conversion rules of a first type defining data as a type of a class of a conversion model, a second type defining a relationship between data, and a third type defining a value that a specific URI has and a type of the value.

According to another aspect of the present invention, there is provided an apparatus for connecting NoSQL data and linked data, including: a first converting module configured to convert the NoSQL data into RDF data, and issue the converted RDF data as the linked data; and a second converting module configured to collect extended linked data extended by connecting the issued linked data and external linked data, and store the collected extended linked data as the NoSQL data.

As an embodiment, the first converting module may convert the NoSQL data which is a target into a middle format of a type which is compatible with the RDF data, and convert the converted NoSQL data into the RDF data by applying a predetermined data conversion rule to the NoSQL data converted into the middle format.

As an embodiment, the first converting module may select the NoSQL data including a key defined in the predetermined data conversion rule as the NoSQL data which is the target with reference to the predetermined data conversion rule.

As an embodiment, the first converting module may perform verification on the converted RDF data with reference to schema information defined in a predetermined ontology model.

As an embodiment, the second converting module may receive collection queries being executed on at least one LOD which is a collection target of the extended linked data, and collect the extended linked data by executing the received collection queries.

As an embodiment, the second converting module may store the collected extended linked data as the NoSQL data using an API supported by a NoSQL database.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a conceptual diagram for describing a virtuous circulation structure of NoSQL data and linked data according to embodiments of the present invention;

FIG. 2 is a conceptual diagram for describing a mechanism for constructing a virtuous circulation structure of NoSQL data and linked data according to embodiments of the present invention;

FIG. 3 is a block diagram for describing an apparatus for connecting NoSQL data and linked data according to embodiments of the present invention;

FIG. 4A and FIG. 4B are diagrams illustrating an example of converting NoSQL data into linked data according to an embodiment of the present invention;

FIG. 5A and FIG. 5B are diagrams illustrating an example of converting linked data into NoSQL data according to embodiments of the present invention;

FIG. 6 is a diagram for describing a data conversion rule according to an embodiment of the present invention;

FIG. 7A and FIG. 7B are diagrams for describing an example of a data conversion rule according to an embodiment of the present invention; and

FIG. 8 is a flowchart for describing a method of connecting NoSQL data and linked data according to an embodiment of the present invention;

### DETAILED DESCRIPTION OF EXEMPLARY EMBODIMENTS

Hereinafter, in the following description with respect to embodiments of the present invention, when a detailed description of known functions or configurations related to the present invention unnecessarily obscures the gist of the present invention, a detailed description thereof will be omitted.

Not only structured query language (NoSQL) data may be a new data type for storing and managing effectively big data generated in a cloud computing environment, and may not have a fixed schema, may not store a relationship between data, and may be stored in a distributed form.

Linked data may be opened and distributed through a network (for example, a HTTP protocol), and may be open data for connecting and collaborating with other data. The linked data may be acquired using a query language, for example, a sparql protocol and RDF query language (SPARQL) accessing an external resource through a uniform resource identifier (URI)-based HTTP dereference, issuing a holding information in a machine-readable form to the Web through a resource description framework (RDF), and, querying to internal information or external holding information.

As described above, since each of the two types of data may have advantages and disadvantages, in embodiments of the present invention, a virtuous circulation structure of NoSQL data/linked data for utilizing advantages of each data and mutually compensating disadvantages of each data by connecting the NoSQL data and the linked data may be constructed, and a mechanism for implementing the structure, and a construction for embodying the structure may be provided.

In embodiments of the present invention, the NoSQL data/linked data may be a structure capable of accessing the linked data through the NoSQL data and accessing the NoSQL data through the linked data.

In embodiments of the present invention, the NoSQL data and the linked data may be connected at a data level.

Hereinafter, the embodiments of the present invention will be described with reference to accompanying drawings.

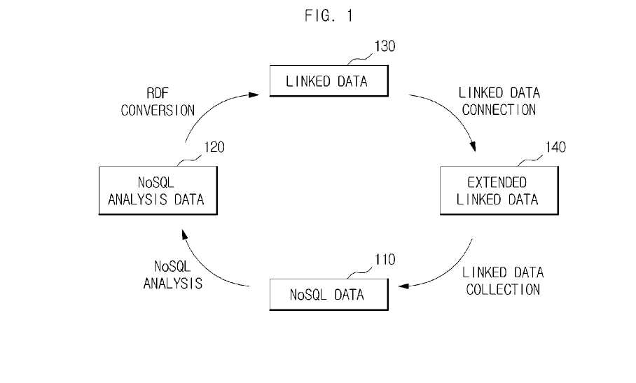

FIG. 1 is a conceptual diagram for describing a virtuous circulation structure of NoSQL data and linked data according to embodiments of the present invention.

As shown in FIG. 1, NoSQL data 110 may be converted into NoSQL analysis data 120 through a NoSQL analysis, and the converted NoSQL analysis data 120 may be converted into linked data 130 through an RDF conversion. Here, the converted linked data 130 may be connected with external linked data, and semantically extended linked data 140 may be generated by being connected with the external linked data. The extended linked data 140 may have a virtuous circulation structure since it used as the NoSQL data 110 again through linked data collection.

For example, suppose that the NoSQL data is temperature information collected from weather sensors located at various positions. The collected information may be analyzed, and a daily/weekly/monthly average temperature of each position may be obtained. The obtained daily/weekly/monthly average temperature of each position may be converted into the RDF data type.

The converted information may be extended to information including geographical information indicating whether a corresponding area is a large city, a rural area, or a tourist spot through a connection with the external linked data related to geographical information. Further, when the analyzed area is the tourist spot, the converted information may be connected with the external linked data related to the number of summer vacationers of the corresponding tourist spot, and the connected information may be used as basic data, that is, the NoSQL data, for another NoSQL analysis. It may be possible to analyze a correlation of the average temperature and the number of summer vacationers of a summer vacation season based on the extended information.

That is, after analyzing the temperature information of the corresponding area, the perspective of a data analysis by connecting and extending information of the corresponding area and other necessary information may be extended, and the extended information may be used as basic data for a comparison and an analysis, etc. Further, the correlation information between the daily/weekly/monthly average temperature and the number of summer vacationers analyzed from the NoSQL data may be converted into the linked data, and the converted linked data may be used as the basic data for an inference service and a context awareness service, etc.

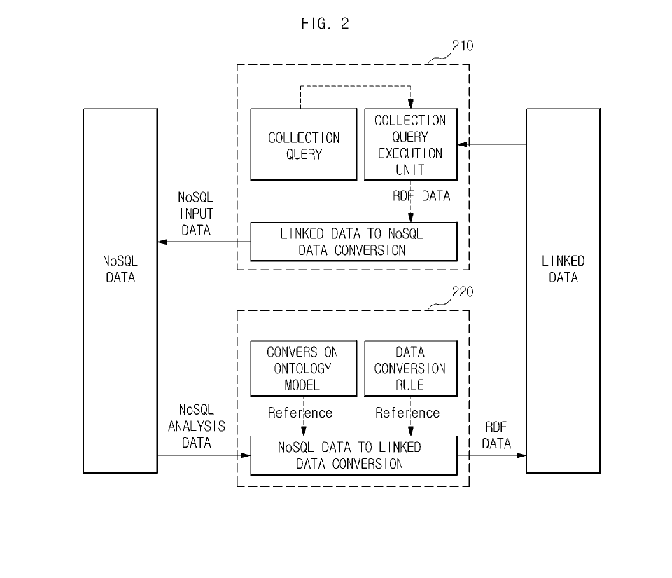

FIG. 2 is a conceptual diagram for describing a mechanism for constructing a virtuous circulation structure of NoSQL data and linked data according to embodiments of the present invention.

A concept of a NoSQL data-linked data conversion 220 may be as follows.

A NoSQL data analysis with respect to the NoSQL data may be performed and the NoSQL data in which the NoSQL analysis is performed may be converted into RDF data through a NoSQL data-linked data conversion. The converted RDF data may be issued as linked data.

In order to convert into the RDF data, the NoSQL data may be converted into a middle format such as a JavaScript object notation (JSON) format, etc., and the NoSQL data converted into the middle format may be converted into the RDF data according to a predetermined data conversion rule. The converted RDF data may be verified with reference to schema information defined in a predetermined ontology model, and the defined RDF data may be issued as the linked data.

The issued linked data may extend its meaning by being connected with the external linked data.

A concept of a linked data-NoSQL data conversion 210 may be as follows.

Collection queries with respect to linked open data (LOD) which is a collection target may be input (hereinafter, “input” may be used as a meaning including “load”), the linked data may be collected by executing the input collection queries. The linked data may include the extended linked data in which its meaning is extended. The collected linked data may be stored as the NoSQL data according to an application program interface (API) supported by a NoSQL database.

The stored NoSQL data may be used as basic data for a data analysis.

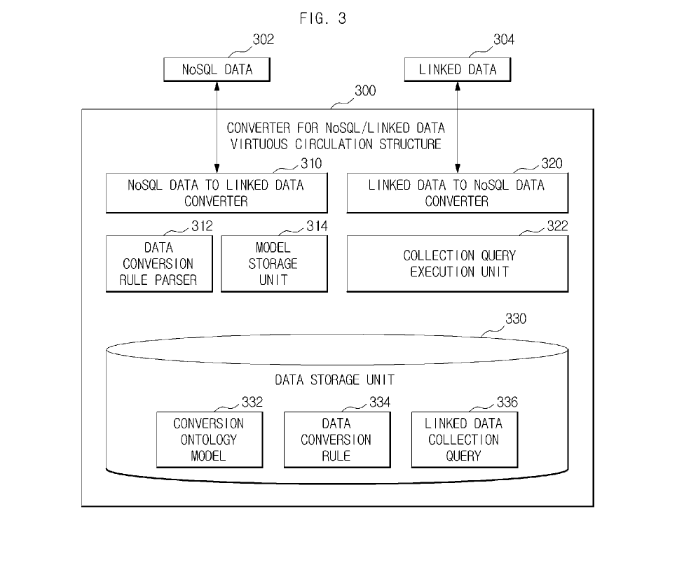

FIG. 3 is a block diagram for describing an apparatus for connecting NoSQL data and linked data according to embodiments of the present invention. According to an embodiment, at least a part of the components shown in FIG. 3 may be omitted.

An apparatus for connecting the NoSQL data and the linked data (a converter for a NoSQL/linked data virtuous circulation structure) according to the embodiments of the present invention may include a NoSQL data to linked data converter 310, a linked data to NoSQL data converter 320, and a data storage unit 330.

The NoSQL data to linked data converter 310 may convert the NoSQL data into the linked data, and issue the converted linked data to the Web. Hereinafter, assume that the NoSQL data converted into the linked data is the analyzed NoSQL data described with reference to FIG. 1.

For data conversion, first, the NoSQL data to linked data converter 310 may select target NoSQL data for converting the NoSQL data into the linked data. To select the target NoSQL data, the predetermined data conversion rule may be referred. For example, the NoSQL data to linked data converter 310 may select the NoSQL data including a key defined in the predetermined data conversion rule as the target NoSQL data.

The NoSQL data to linked data converter 310 may convert the selected target NoSQL data into a JSON format, etc. capable of being compatible with the RDF type, as a middle operation for converting the selected target NoSQL data into the RDF data which is a data model of the linked data.

The NoSQL data to linked data converter 310 may generate the RDF data by applying the data conversion rule to the NoSQL data converted into the JSON format, and issue the generated RDF data as the linked data. For this, the NoSQL data to linked data converter 310 may include a data conversion rule parser 312 loading the data conversion rule, and parsing the loaded data conversion rule.

In an embodiment, verification by a conversion ontology model 332 prescribing schema information of the linked data which is the collection target may be performed on the generated RDF data, and only the RDF data passing the verification may be issued as the linked data. For this, the NoSQL data to linked data converter 310 may include a model storage unit 314 loading the conversion ontology model 332 and storing the loaded conversion ontology model 332.

The operation may be repeatedly performed on each of the collected (analyzed) NoSQL data.

The linked data to NoSQL data converter 320 may collect the linked data of the RDF type (including the extended linked data), convert the collected linked data into the NoSQL data, and store the converted NoSQL data.

For the data conversion, first, the linked data to NoSQL data converter 320 may execute a predetermined linked data collection query 336, and collect the linked data. The predetermined linked data collection query 336 may include queries capable of executing with respect to at least one LOD which is the collection target of the linked data. For example, the queries may be written by a user, and be written as SPARQL which is a World Wide Web consortium (W3C) standard query language. In order to collect the linked data, the linked data to NoSQL data converter 320 may include a collection query execution unit 322 loading the linked data collection query 336, executing the loaded linked data collection query 336 according to predetermined scheduling, and collecting the linked data.

The linked data to NoSQL data converter 320 may convert the collected linked data into the NoSQL data, and store the converted NoSQL data. For example, the linked data to NoSQL data converter 320 may convert the collected linked data into the NoSQL data according to the API supported by the NoSQL database, and store the converted NoSQL data.

The data storage unit 330 may store at least one among the conversion ontology model 332, the data conversion rule 334, and the linked data collection query 336. If necessary, information stored in the data storage unit 330 may be loaded and used by the components described above.

The conversion ontology model 332 may store schema information which is the collection target as basic information for the data conversion.

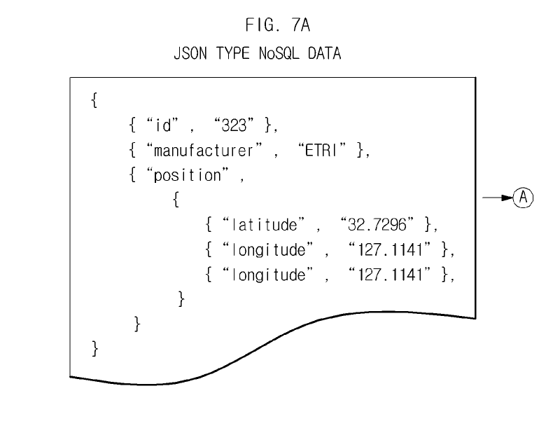

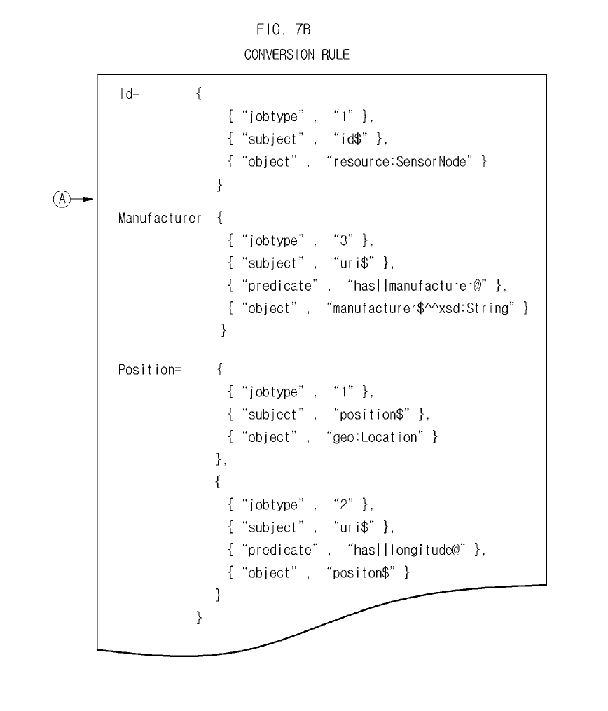

The data conversion rule 334 may have a rule for converting the collected NoSQL data into the linked data. A detailed description with respect to the data conversion rule 334 will be described hereinafter with reference to FIG. 7.

The linked data collection query 336 may store queries for collecting the linked data. The queries may include the queries for executing on at least one LOD.

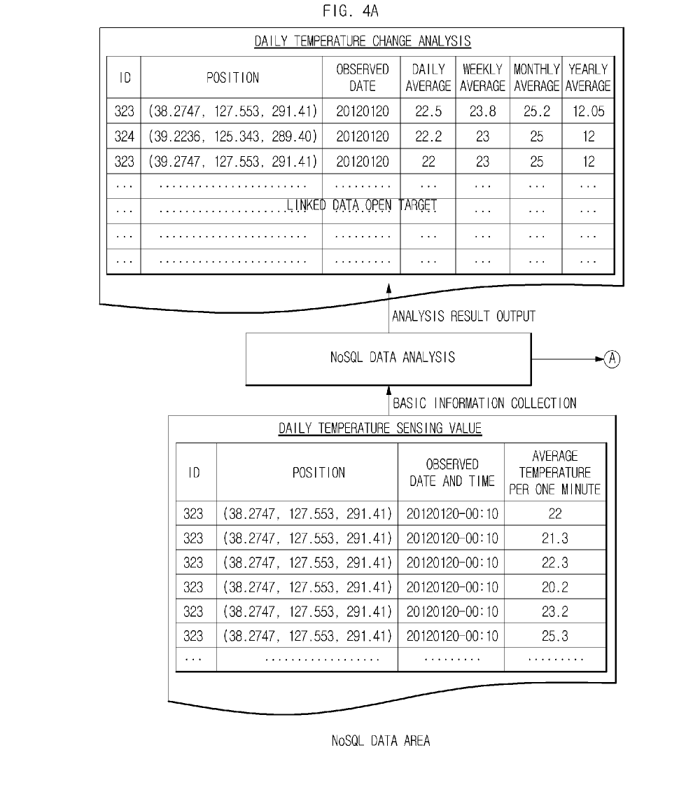

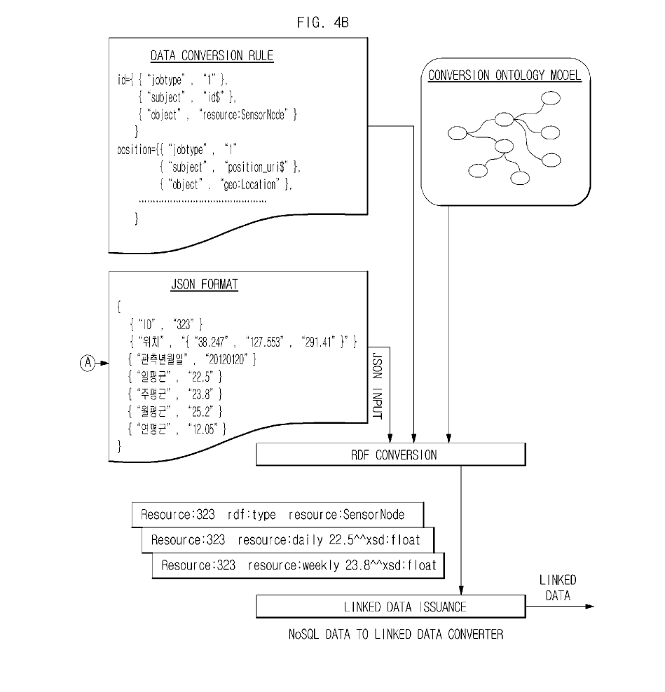

FIG. 4A and FIG. 4B are diagrams illustrating an example of converting NoSQL data into linked data according to embodiments of the present invention.

First, as shown in FIG. 4A, suppose that an average temperature value is collected in units of one minute from weather sensors (ID: 323, 324, etc.) installed in various positions. The quantitative arrangement analysis with respect to the collected information may be performed, and as the analysis result, a daily average temperature value, a weekly average temperature value, and a monthly average temperature value with respect to each sensor may be obtained.

Here, suppose that every obtained analysis result may be selected as target data capable of connecting with every linked data. In order to convert into the RDF data, the selected data may be converted (generated) into JSON data (data represented as the JSON type or data of the JSON format) which is data of the middle operation.

Referring to FIG. 4B, the JSON data may include a key or a value. For example, the key {“ID”, “323”} among the JSON data may be ID, the value may be “323”. The JSON data may have a light data transmission format, and the data format of the JSON data may be the most similar to that of the RDF data. Accordingly, the JSON data may be the best data type for converting into the RDF format.

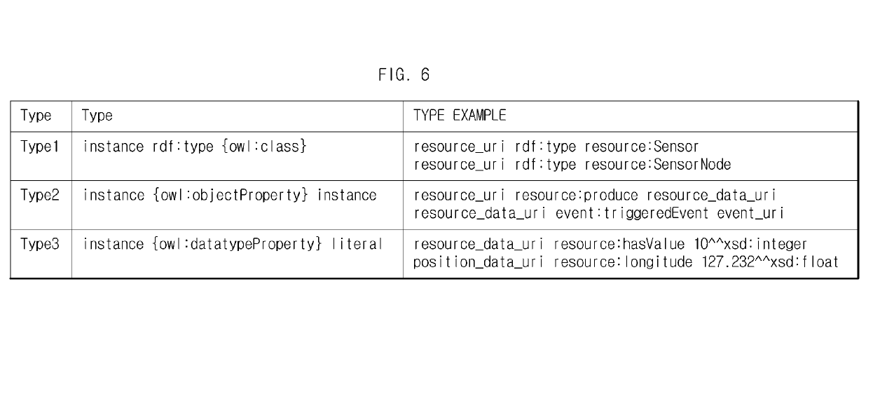

The data conversion rule may be configured as the JSON format, and may be a conversion rule based on the key of input data. For example, the data conversion rule may define a conversion rule of each structure type of a triple structure (subject, predicate, object) which is a basic data structure of the RDF type. A detailed description of the data conversion rule will be described hereinafter with reference to FIG. 6.

The conversion ontology model may be an ontology schema model for ontology annotation of the NoSQL data. The conversion ontology model may include the schema model with respect to the linked data which is the collection target which is previously input by a user. The conversion ontology model may be used in a verification job with respect to each term of the ontology vocabulary defined in the data conversion rule when converting the NoSQL data into the RDF data.

The RDF data may be generated using the converted data conversion rule and conversion ontology model, and the generated RDF data may be issued as the linked data.

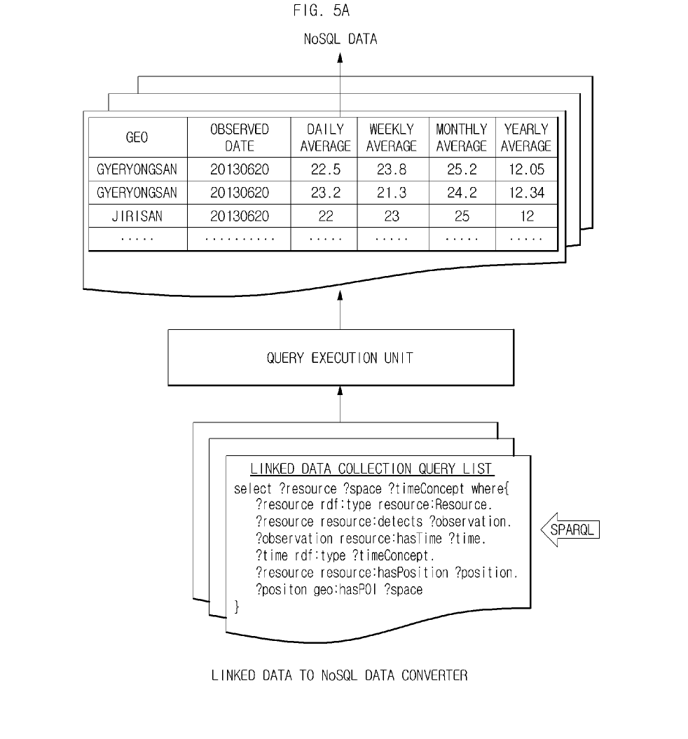

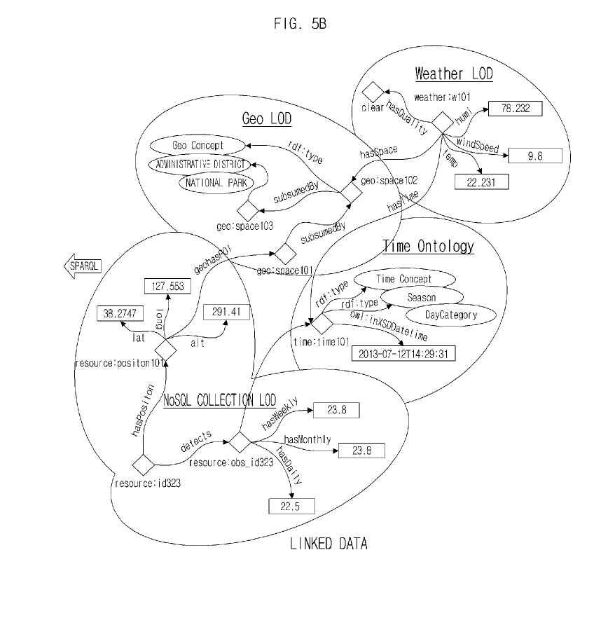

FIG. 5A and FIG. 5B are diagrams illustrating an example of converting linked data into NoSQL data according to embodiments of the present invention.

Referring to FIG. 5A and FIG. 5B, the linked data issued by being converted into the RDF type may be semantically extended by being connected with other LODs.

For example, as shown in FIG. 5B, the linked data issued by being converted into the RDF type, that is, a NoSQL collection LOD, may be connected to a Geo LOD through the ID (id: 323) and a position (position 101), and may be connected to an internal time ontology through a sensing time (time 101), and the weather LOD may be connected to corresponding Geo value (space 102) and time value (time 101).

The linked data may be a more extended data than a first converted NoSQL data. Accordingly, the extended linked data may be collected using the collection query.

The linked data collected by the collection query may be used as basic data for analyzing the NoSQL data, and the analysis perspective may be extended when analyzing the data by using as the basic data.

For example, the linked data related to an initial position (position 101) may be extended by being connected with the external linked data (for example, the Geo LOD, data belonging to the weather LOD). The extended linked data may be collected and stored, and may be used as basic data for analyzing the NoSQL data, at this time, an analysis perspective of the extended linked data used as the basic data may be extended to not only an analysis of the average temperature related to each coordinate value corresponding to the initial position (position 101) but also a weather analysis with respect to an area (for example, Gyeryongsan) in which a specific meaning is assigned.

FIG. 6 is a diagram for describing a data conversion rule according to an embodiment of the present invention.

In an embodiment of the present invention, the data conversion rule may receive the JSON data, and describe a rule of converting the received JSON data into the RDF data. In an embodiment of the present invention, three job types of the data conversion rule may be defined as follows.

Type 1 may define specific data as a class type of a conversion model.

“instance rdf:type {owl:Class}” shown in FIG. 6 may represent triple data (subject: instance, predicate:rdf:type, object:owl:Class) of the RDF data structure. Here, instance may be a value representing specific data of the NoSQL data as URI, rdf:type may be a RDF predefined keyword representing that specific data belongs to a specific ontology class, and owl:Class may represent a specific class of a data conversion model.

For example, “resource:323 rdf:type resource:Resource” may represent that “resource:323 belongs to a class of resource:Resource”.

Type 2 may define a relationship between data.

As shown in FIG. 6, type 2 may have a type of “instance {owl:ObjectProperty} instance”, and may represent a job of converting the data converted into the NoSQL data into data related as a relationship of a specific owl:ObjectProperty affiliation.

For example, “resource323 resource:hasPosition position:323_{—}1” may represent that “URI resource:323 has a position of URI position:323_{—}1”.

Type 3 may define the value that the specific URI has, and a type of the value.

As shown in FIG. 6, type 3 may have a type of “instance {owl:DatatypeProperty} literal”, and may represent that “URI has a specific literal value and type as a class of owl:DatatypeProperty affiliation”.

For example, “resource:323 resource:daily 22.5̂̂xsd:float” may represent that “URI 323 has a value of float 22.5 as a daily average value”.

The data conversion may be performed by the three job types described above, a combination of the triple data generated through each data conversion may represent a meaning of the NoSQL data.

For example, a combination of the triple data which is {resource:323 rdf:type resource: SensorNode}, {resource:323 resource:hasPosition positon:323_{—}1}, {positon:323_{—}1 postion:hasLongitude 127.553̂̂xsd:float}, {resource:323 resource:daily 22.5̂̂xsd:float} may represent that “longitude of a position of a sensor node 323 is 127.553 and its daily average value is 22.5”.

The triple job types described with reference to FIG. 6 may be used in the data conversion rule, and a job type may be described in each data conversion rule. This will be described with reference to FIG. 7A and FIG. 7B.

FIG. 7A and FIG. 7B are diagrams for describing an example of a data conversion method according to an embodiment of the present invention.

An example that the data conversion rule of each key (id, manufacturer, position) of JSON data shown in FIG. 7A is defined is illustrated in FIG. 7B,

As shown in FIG. 7B, the data conversion rule may be data of the JSON type. The keys (id, manufacturer, position) of the data conversion rule may be equal to keys of JSON data which is received. A value of the data conversion rule may be configured as a Sub JSON type having the triple structure (Subject, Predicate, Object) as a key.

For example, the data conversion of the job Type 1 may be performed on {{“id”, {“jobtype”}, “1”}, {“subject”, “id$”}, {“object”, “resource:SensorNode”}} among the data conversion rule, subject may be id$ (a value 323 corresponding to the key (id) of the received JSON data), and the object may represent a class sensor node of a conversion model. Here, the predicate is omitted, as described with reference to FIG. 6, since the predicate of the job Type 1 describes rdf:type, the portion of the predicate of the job Type 1 may be omitted.

As another example, the data conversion rule of {{{“position”, {“jobtype”, “1”}, {“subject”, “position$”}, {“object”, “position:Location”}}; {{“jobtype”,“2”}, {“subject”,“id$”}, {“predicate”, “position@”}, {“object”, “postion$”}}; {“jobtype”, “3”}, {“predicate”, “has∥longitude@̂̂xsd:float”}, {“object”, “longitude$”}}} may represent that a data key of the received JSON data is configured as triple job types, and first, the job type 1 defines a value of a URI position as a type of a conversion model class position:Location, second, the job type 2 defines a job of connecting a URI id and a URI position as a relationship of position@ (that is, a key name of the received JSON data), and third, the job type 3 defines a job of converting the URI position into a type having the longitude value.

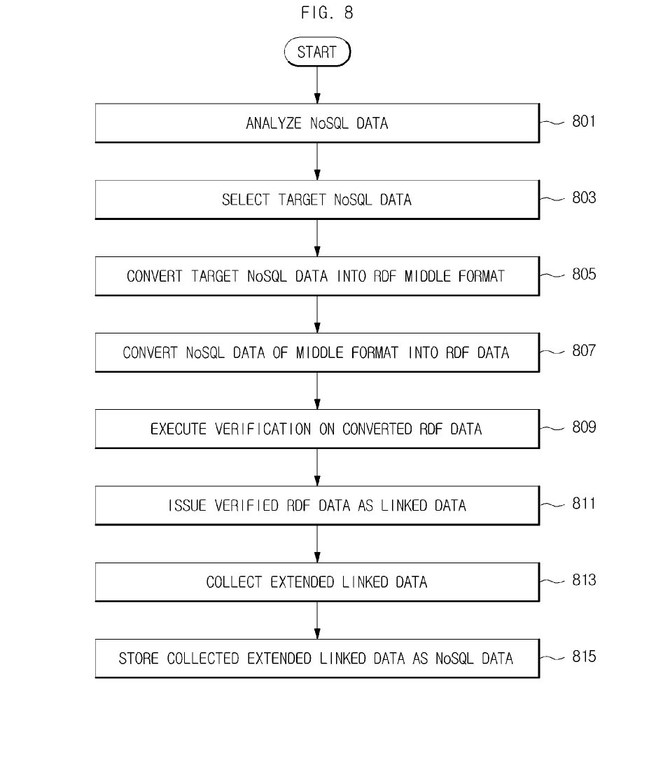

FIG. 8 is a flowchart for describing a method of connecting NoSQL data and linked data according to an embodiment of the present invention. According to an embodiment, at least one of operation 801 and operation 815 shown in FIG. 8 may be omitted.

In operation 801, a NoSQL data analysis may be performed, and the analysis may be a statistical arrangement analysis with respect to collected data.

In operation 803, the NoSQL data which is a target for converting into the linked data may be selected. In an embodiment, all NoSQL data analyzed in operation 801 may be selected as the target NoSQL data, or some of the NoSQL data may be selected as the target data. As an embodiment, the predetermined data conversion rule may be referred to for selecting the NoSQL data. For example, the NoSQL data including the key defined in the predetermined data conversion rule may be selected as the target data.

In operation 805, the target NoSQL data may be converted into a RDF middle format. The RDF middle format may be a format of a type capable of being compatible with the RDF type, for example, may be the JSON format.

In operation 807, the NoSQL data of the middle format may be converted into the RDF data. The data conversion rule may be applied for converting into the RDF data.

In operation 809, a verification on the converted RDF data may be performed. A conversion ontology model prescribing schema information of the linked data which is a collection target may be used for the verification.

In operation 811, the verified RDF data may be issued as the linked data. For example, the issuance may be an issuance through the Web.

In operation 813, the extended linked data may be collected. The extended linked data may be data extended by connecting the linked data issued in operation 811 with the external linked data.

In operation 815, the collected extended linked data may be stored as the NoSQL data. The storing may be performed based on an API supported by the NoSQL database.

According to the embodiments of the present invention, the present invention can construct a dynamic virtuous circulation structure capable of utilizing advantages and mutually compensating for disadvantages of each of the NoSQL data and the linked data. Through the virtuous circulation structure, initially collected data may be semantically extended, and thus value of data may be increased.

The embodiments of the present invention described above may be implemented by arbitrary various methods. For example, the embodiments of the present invention may be implemented by hardware, software, or in combination.

When being implemented by the software, the embodiments of the present invention may be implemented by the software executed on one or more processor using various operating systems or platforms. In addition, the software may be programmed using any one among various suitable programming languages, or be compiled as a middle code or machine codes which are executable in a framework or a virtual machine.

Further, when the embodiments of the present invention are executed on one or more processors, the embodiments of the present invention may be implemented as a processor readable medium (for example, a memory, a floppy disk, a hard disk, a compact disk, an optical disk, or a magnetic tape, etc.) in which one or more programs for performing the methods implementing the embodiments of the present invention are recorded.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of connecting NoSQL data and linked data, comprising:
converting the NoSQL data into RDF data, and issuing the converted RDF data as the linked data;
collecting extended linked data extended by connecting the issued linked data and external linked data; and
storing the collected extended linked data as the NoSQL data.

2. The method of claim 1, wherein the converting of the NoSQL data into the RDF data comprises:
converting the NoSQL data which is a target into a middle format of a type which is compatible with the RDF data; and
converting the converted NoSQL data into the RDF data by applying a predetermined data conversion rule to the NoSQL data converted into the middle format.

3. The method of claim 2, further comprising:
selecting the NoSQL data including a key defined in the predetermined data conversion rule as the NoSQL data which is the target with reference to the predetermined data conversion rule.

4. The method of claim 2, wherein the middle format and the predetermined data conversion rule have a JSON format.

5. The method of claim 1, further comprising:
performing a verification on the converted RDF data with reference to schema information defined in a predetermined ontology model.

6. The method of claim 1, wherein the collecting of the extended linked data comprises:
receiving collection queries being executed on at least one LOD which is a collection target of the extended linked data; and
collecting the extended linked data by executing the received collection queries.

7. The method of claim 6, wherein the collection queries are written as SPARQL.

8. The method of claim 1, wherein the storing of the collected extended linked data as the NoSQL data comprises:
storing the collected extended linked data as the NoSQL data using an API supported by a NoSQL database.

9. The method of claim 2, wherein the data conversion rule comprises: at least one among conversion rules of a first type defining data as a type of a class of a conversion model, a second type defining a relationship between data, and a third type defining a value that a specific URI has and a type of the value.

10. An apparatus of connecting NoSQL data and linked data, comprising:
a first converting module configured to convert the NoSQL data into RDF data, and issue the converted RDF data as the linked data; and
a second converting module configured to collect extended linked data extended by connecting the issued linked data and external linked data, and store the collected extended linked data as the NoSQL data.

11. The apparatus of claim 10, wherein the first converting module converts the NoSQL data which is a target into a middle format of a type which is compatible with the RDF data, and converts the converted NoSQL data into the RDF data by applying a predetermined data conversion rule to the NoSQL data converted into the middle format.

12. The apparatus of claim 11, wherein the first converting module selects the NoSQL data including a key defined in the predetermined data conversion rule as the NoSQL data which is the target with reference to the predetermined data conversion rule.

13. The apparatus of claim 11, wherein the middle format and the data conversion rule have a JSON format.

14. The apparatus of claim 10, wherein the first converting module performs a verification on the converted RDF data with reference to schema information defined in a predetermined ontology model.

15. The apparatus of claim 10, wherein the second converting module receives collection queries being executed on at least one LOD which is a collection target of the extended linked data, and collects the extended linked data by executing the received collection queries.

16. The apparatus of claim 15, wherein the collection queries are written as SPARQL.

17. The apparatus of claim 10, wherein the second converting module stores the collected extended linked data as the NoSQL data using an API supported by a NoSQL database.

18. The apparatus of claim 11, wherein the data conversion rule comprises: at least one among conversion rules of a first type defining data as a type of a class of a conversion model, a second type defining a relationship between data, and a third type defining a value that a specific URI has and a type of the value.
